(19) United States
(12) Patent Application Publication
(10) Pub. No.: US 2011/0173549 A1
(43) Pub. Date: Jul. 14, 2011

(54) INTERACTIVE KIOSK SYSTEM AND METHOD

(76) Inventor: Kelly T. Hipskind, Indianapolis, IN (US)

(21) Appl. No.: 13/053,273

(22) Filed: Mar. 22, 2011

Related U.S. Application Data
(60) Provisional application No. 61/347,675, filed on May 24, 2010.

(51) Int. Cl. G06F 15/16; G06Q 40/00; G06F 7/00; G06F 3/048

(52) U.S. Cl. 715/756; 705/43; 700/232; 715/753

(57) ABSTRACT

Provided is an interactive kiosk system and method of use. Certain embodiments of a kiosk system may provide users with a wide variety of targeted information, materials and/or services that can be separately administered remotely by multiple unique parties, such as, for example, a plurality of advertisers and one or more managers. In certain embodiments, an interactive kiosk may include videoconferencing capability so that a manager can provide virtual face-to-face assistance to a user. In certain embodiments, an interactive kiosk provides a uniform interface adapted to allow the user to interact with the reservation systems of a plurality of third-parties when the user's identification or payment information is entered only once.

### BACKGROUND OF THE INVENTION

1. Field of the Invention

The present invention relates to an interactive kiosk system and method of use.

2. Description of Related Art

Kiosks are used in various settings for specific purposes. For example, Automated Teller Machines (ATM's) may be provided in the form of a kiosk in convenience stores, casinos, and other public places. Such kiosks are typically single-purpose devices; they provide money to users, and are connected to and controlled by a single financial institution that may communicate with other financial institutions through a banking network. Other examples include ticketing kiosks, for instance at airport check-in counters, or other locations where tickets are purchased or validated using a kiosk, such as parking garages. Once again, these kiosks are typically designed for a specific limited purpose and are connected to and controlled by a single entity.

Recently, a need has been recognized for a more versatile kiosk system having the capability of providing users with a wider variety of information, materials and/or services. However, typical kiosk providers, such as banks and airlines, have limited business motivation to expand the capability of their kiosks beyond the purposes unique to their respective businesses.

### SUMMARY

The present invention addresses these issues and more with a novel system and method that electronically networks together multiple unique parties, such as advertisers, to provide a wide variety of targeted information, materials and/or services to users of a kiosk. A plurality of the kiosks may be provided in various locations, and a party may be in remote electronic communication with any number of the kiosks based on predetermined criteria such as the kiosks' geographic locations or location types, for instance according to a subscription plan. Approved parties can separately administer their accounts on the kiosks remotely, for instance through a web page interface on the Internet. In administering their account, each party can in certain example embodiments remotely add, remove, or change their content and offerings that appear on, or are available through, each kiosk. In certain embodiments, parties may also remotely monitor users' activity with respect to each kiosk. One or more managers may also be in remote electronic communication with the kiosks and their users, with each other, and with the parties, for instance to monitor and administer the overall system.

Provided in various embodiments is an interactive kiosk system, comprising at least one electronic kiosk located in a public place and adapted to provide a public user with information and objects relating to a plurality of parties, said kiosk: having input means and output means; in electronic communication with the parties through a network such that each party can remotely control the content and availability on the kiosk of each party's respective information and materials; adapted to dispense an object relating to a party upon selection by the user; and adapted to electronically communicate information relating to a party to a device of the user upon selection by the user. In various embodiments the input means may comprise a touch screen. The object relating to a party may be at least one of, for example, a: room key card; lottery ticket; receipt; map; gift card; event ticket; transportation ticket. The information communicated to a device of the user may be communicated in the form of at least one of, for example, an: email; SMS message; MMS message. The information communicated to a device of the user may comprise at least one of, for example: a coupon; driving directions; reservations; contact information for the party; a menu. The kiosk may further comprise an ATM. In certain embodiments the input means may comprise a first screen and the output means may comprise a second screen. The kiosk may further comprise a uniform interface means adapted to allow the user to interact with the reservation systems of a plurality of third-parties when the user's identification or payment information is entered only once. A kiosk may further comprise videoconferencing means, and the system may further comprise a manager in electronic communication with the kiosk through a network such that the manager and the user can see and hear each other using the videoconferencing means, for instance so that the manager can provide the user with virtual face-to-face concierge or other assistance. A manager may also be provided in electronic communication with the kiosk through a network such that the manager can control the parties' access to the kiosk.

Also provided is a method of providing a public user with information relating to one of a plurality of parties, comprising providing a publicly located electronic kiosk as described above, and electronically communicating information relating to one of the parties to a device of the user upon the user's interaction with the kiosk. Such a method may also or alternatively comprise dispensing an object relating to one of the parties upon the user's interaction with the kiosk. The information communicated to a device of the user may be communicated in the form of at least one of, for example, an: email; SMS message; MMS message. The information communicated to a device of the user may comprise at least one of, for example: a coupon; driving directions; reservations; contact information for the party; a menu. Like the other embodiments, the kiosk in the method may further comprise an ATM and/or videoconferencing means, and the input means may comprise a first screen and the output means may comprise a second screen. The method may also comprise controlling the parties' access to the kiosk by electronically communicating with the kiosk through a network, and/or the manager and the user communicating with each other through the videoconferencing means. Also provided is a method of using uniform interface means on the kiosk to allow the user to interact with the reservation systems of a plurality of third-parties by entering the user's identification or payment information only once.

The foregoing summary is provided to show examples of the invention and not to define or otherwise limit the scope of the invention.

### BRIEF DESCRIPTION OF THE DRAWINGS

FIG. 1 is a diagram of an example system according to certain embodiments of the invention.

In the following description, like reference numbers from the FIGURE may be used to refer to like elements/features in connection with various different embodiments.

### DETAILED DESCRIPTION OF EXAMPLE EMBODIMENTS

Reference will now be made in detail to some specific examples of the invention, including any best mode contemplated by the inventor for carrying out the invention. Examples of these specific embodiments are illustrated in the accompanying drawings. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention.

Various techniques and mechanisms of the present invention will sometimes be described in singular form for clarity. However, it should be noted that some embodiments include multiple iterations of a technique or multiple mechanisms unless noted otherwise. For example, a system may utilize a network. However, it will be appreciated that a system can use multiple networks while remaining within the scope of the present invention unless otherwise noted.

Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. For example, several entities are described as connected by, or communicating through, various networks, but it will be appreciated that a variety of computer networks, phone lines, satellite communications, wireless networks and the like may exist between the entities shown. Consequently, an indicated connection does not necessarily mean a direct, unimpeded connection unless otherwise noted.

Kiosks

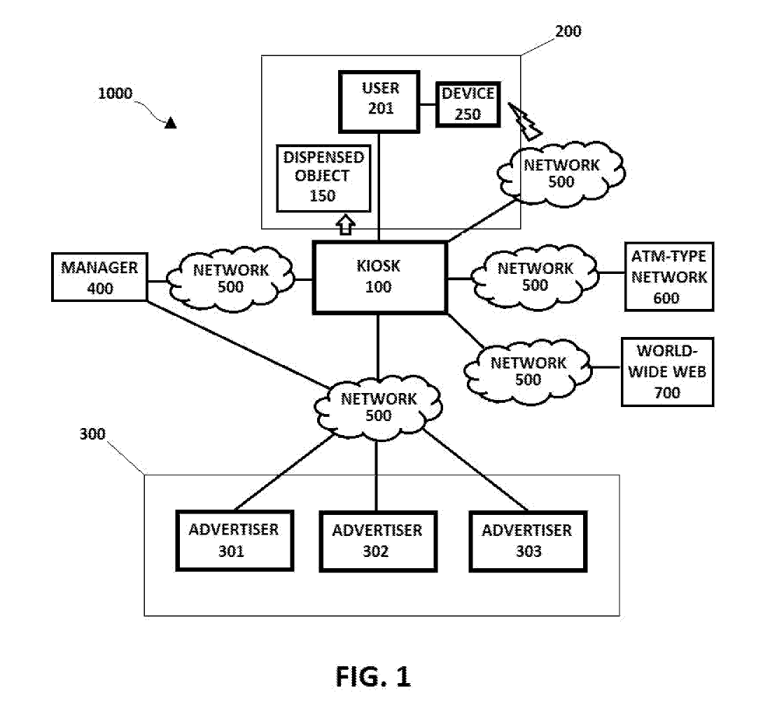

Turning now to FIG. 1, provided is an example interactive kiosk system 1000. The system 1000 includes one or more kiosks 100 adapted to provide users 200, such as members of the public, with information, materials and/or services. Kiosks 100 may be placed at any location, including but not limited to in shopping malls or centers, airports, hotels, motels, hospitals, convention centers, grocery stores, sporting event locations, businesses, restaurants, bars, stores, liquor stores, coffee shops, airplanes, real estate offices, sales offices, model homes, homes for sale, medical practices, hospitals, offices, electronic retail stores, home improvement stores, hardware stores, spas, gyms, salons, clothing stores, golf courses, country clubs, tennis clubs, ski shops, ski resorts, outdoor retail locations, banks, law firms, car rental locations, cabs, limousines, trains/stations, subways/stations, buses/stations, ships/docks, public transportation areas, in elevators, schools, trade shows, event locations, or mobile locations. Kiosks 100 can be stand-alone, wall-mounted, desk, table, or countertop-top mounted or integrated, or integrated with another structure, and/or mobile for transport purposes.

Kiosks 100 may include information input and output means (not shown) to facilitate interaction and communication between users 200 and the kiosk 100, and in some embodiments between users 200 and managers 400, through the kiosk 100. Input means may include, for example, one or more touch-screens, keyboards, microphones, cameras, motion sensors, proximity sensors, buttons, switches, computer peripherals, wires, cables, wireless antennas, card/magnetic strip readers or any other suitable data input means, as well as video conferencing means, which may include any of the input and output means mentioned herein. The input means is typically in electronic communication with a processor and/or data storage or memory that are adapted to process the input of the users 200 and provide responsive information or actions to the users 200 through output means. The processor and/or data storage or memory means of a kiosk 100 may be adapted to record data regarding certain or all interactions of users 200 with the kiosk 100. In addition to tracking the number of users 200 that actually use the kiosk 100, the kiosk 100 may use a camera or other means in conjunction with video analytics to count the number of people that come to the machine without actually using it.

Example output means may include one or more electronic screens (such as, for example, LCD, plasma, CRT, or any other suitable image producing devices), speakers, holographic or other three-dimensional image generators, printers/paper-dispensers (such as a thermal receipt printer and/or regular printer with ink), card dispensers or dispensers of any object 150 whatsoever, including but not limited to money, consumer products, hotel room keys, maps, gift cards, coupons, boarding passes, event tickets, lottery tickets, receipts, and the like. Dispensed objects 150 may include pre-manufactured items, and/or items that are processed in real-time by the kiosk 100 or by another entity in electronic communication with the kiosk 100, for instance by encoding a magnetic strip on a card, or by printing user or interaction-specific information on the objects 150, such as selected or winning lottery numbers, event and seating information, or any other desirable information. In certain embodiments, no means is provided for dispensing an object 150.

Output means may also include electronic signal transmission capability, such as means for generating and sending an email, SMS message, MMS message, or other electronic message. For example, as shown in FIG. 1, a user 201 may interact with a kiosk 100, such as a two-screen kiosk 100 with a touch screen input device and a video screen output device. In that example, the user 201 can for instance select an advertised coupon by touching the touch screen on the kiosk 100. A hard copy of the coupon 150 can then optionally be printed or otherwise dispensed from the kiosk 100, if that kiosk 100 is provided with such a dispenser. Alternatively or simultaneously, the kiosk 100 can optionally send an electronic message incorporating the coupon or the coupon's relevant information, for instance by email or MMS message or any other appropriate technology. Such a message can be transmitted either wirelessly or by wire from the kiosk 100 to the appropriate network 500, such as the Internet and/or a wireless phone network. The network 500 can then deliver the message to a device 250 accessible to the user 201, for instance by a wireless network 500 to a wireless phone, PDA, computer or other device 250. The user 201 can then present the coupon 150 or the coupon's information on the device 250 to the providing retailer for redemption. Note that the coupon example is just illustrative of the concept, and is not limiting. For example, the electronic message can comprise any desired information or data, such as turn-by-turn map directions to a location advertised on the kiosk, which may be automatically generated and electronically transmitted by the kiosk 100 to a device 250 on command of the user 201.

Depending on the functionality provided by a kiosk 100, it may be in electronic communication with any of a variety of networks 500. For example, in addition to or alternatively to the network 500 described above for communicating with a device 250 of a user 201, where the kiosk 100 provides ATM services (e.g., where a dispensed object 150 is money), the kiosk 100 would typically communicate through a secure network 500 to a banking or ATM-type network 600 to access the banking funds of the user 201. In any example, certain information gathered or created by a user 201 through their interaction with the kiosk 100 may optionally be dispensed to the user 201 as part of an object 150 or may be transmitted to a device 250 of a user 201.

In a further example of the flexibility of the present system 1000, kiosk 100 may optionally provide users 200 with limited or unlimited access to the World Wide Web 700, by wired or wireless connection of the kiosk 100 to a network 500 connected to the Internet. Using a connection to the Internet or phone lines or any other medium, kiosk 100 may be in electronic communication with any other desired network, such as an airline ticketing or hotel or car reservation network. The kiosk 100 may also be used to make restaurant reservations, for instance by providing a predetermined link through a network 500 to an existing reservation system for that restaurant, such a third-party Internet-based reservation system. For example, in certain embodiments, the kiosk 100 may provide a single uniform interface, such as a touch screen, windows, or browser-type interface, adapted to allow users 200 to access a variety of third-party reservation systems, such as, for example, restaurants, hotels, rental car agencies, airlines, and golf courses. In examples of these embodiments, a user 201 can enter information identifying him or herself (and in certain embodiments payment information, such as credit card information) into the kiosk 100 one time, and then make reservations on the kiosk 100 with any number of participating third-party reservation systems, all through a single interface on the kiosk 100. In these examples the system 1000 transmits the information regarding the user 201 from the kiosk 100 through a network 500 to third-party reservation systems and databases (which may or may not be advertisers 301-303 et seq.) and automatically populates and/or searches the third-party reservation systems and databases to find, make, and/or pay for, reservations, tickets, and the like. Resulting information from the third-party reservation systems and databases is then communicated by the system 1000 back through a network 500 to the kiosk 100 and/or to a device 250 to be observed by the user 201. The kiosk 100 may also optionally remember any or all information regarding the user 201 to expedite the user's future interactions with the kiosk 100. Accordingly, the system 1000 may allow the user to interact with the reservation systems of a plurality of third-parties when the identification or payment information of a user 201 is entered only once. In certain embodiments databases and/or reservation systems may exist wholly or partially within the kiosk 100 or other parts of the system 1000. The kiosk 100 may also be connected with a group of parties 300 with special rights to the kiosk 100, such as advertisers 301-303 as described below.

Advertisers

As shown in FIG. 1, kiosk 100 may be connected through a network 500 to a group of parties 300, such as advertisers 301-303, that may have special rights to remotely control and/or access certain aspects of the kiosk 100. Such special rights or approvals may have been provided by a manager 400 of the system 1000, for instance in exchange for an advertising subscription. In certain embodiments, the advertising capabilities of the kiosk 100 may be monetized by, for example, selling the advertising capacity of one or more of the output means of the kiosk 100. For instance, a kiosk 100 may include as output means one or more electronic screens akin to computer monitors (not shown). The surface area of these screen(s) may be divided up and allocated to different advertisers, and the screen(s) may show different advertisements at different times. The advertisements may be passive or interactive. Interactive advertisements may be engaged by a user 201 by, for instance, touching the advertisement on a touch screen, or otherwise selecting the advertisement using a mouse, trackball, button, or the like.

In certain embodiments, the kiosk may act as an electronic concierge service for a user 201, with a navigable graphical user interface (GUI) on one or more screens (not shown). GUI's may be customized separately for each kiosk 100, for instance to adapt to the particular location of that kiosk 100. For example, custom directories may be provided that correspond to all the businesses in a specific location (such as the lobby of an office building). Typically, GUI's may include, for example, selectable tabs or other indicia for “restaurants,” “bars,” “entertainment,” “local attractions,” “transportation,” “churches,” “weather,” or any other category that may be expected to be of interest to a user 201 at the location of the kiosk 100. Selecting a category may then bring up listings for nearby corresponding businesses and attractions. In certain embodiments, special or enhanced listings may be provided for certain businesses that, for instance, pay to advertise on the kiosk. These enhanced listings may include pictures, menus, maps, detailed descriptions and information, reviews, videos, coupons, or any other information or material deemed helpful to users 200. Redeemable or reference items such as coupons, maps, menus, contact information, and the like may optionally be dispensed 150 to the user 201 and/or electronically transmitted to a device 250 of the user 201, depending on the capability of the kiosk 100 as described above.

In certain embodiments the foregoing advertising information and data available on the kiosk 100 may be monitored, uploaded, removed, or otherwise changed remotely, in real time, by external parties 300 in electronic communication with the kiosk 100 through a network 500. For example, any number of advertisers, 301, 302, 303, et. seq., may be provided with “back end” access to any number of kiosks 100 on which they advertise. In certain embodiments each advertiser 301 et seq. is provided with unique log-in information that they can use to log-in to a special website or other electronic interface after accessing the interface through a network 500, such as the Internet. The website or other electronic interface is in electronic communication with each kiosk 100 through the network 500. After an advertiser 301 logs-in to the website or other electronic interface, then in certain embodiments they can monitor and control predetermined aspects of their own advertisements on the kiosks 100. For example, the advertiser 301 may be able to review reports on activities of users 200 on each kiosk 100, and users' 200 specific interactions with the advertisements of the advertiser 301. Based on this information, advertisers 301 et seq. can decide which kiosk locations work best for them, and how much the exposure in each kiosk 100 may be worth to them. The advertiser 301 may also optionally be able to use the interface to upload, remove, or otherwise change the content of their advertisements, thereby being able to directly monitor and control their own advertising on each kiosk 100 in real time from any remote location with access to the network 500.

Management

While a group of parties 300, such as advertisers 301-303, may have special rights to remotely control and/or access their own advertisements on the kiosk 100, one or more managers 400 typically retain ultimate control over all the kiosks 100 and the system 1000. The manager 400 is typically in remote electronic communication with the kiosk 100 through a network 500, such as the Internet, and can thereby monitor and control all activities on the kiosk 100. Manager 400 is also typically in remote electronic communication with each advertiser 301 et seq. through the kiosk 100 and/or through a separate network 500.

The manager 400 typically administers the system 1000 including remotely maintaining, organizing and managing the content, features and functionality of the kiosks 100, including advertising. The manager 400 may reserve the right to approve of all advertising on the kiosk 100, and/or may remove advertising that is determined to be inappropriate, or restrict content to users 200 above a certain age. The manager 400 may also act as an assistant for a user 201, for instance by real time chat or video communications with the user 201 through the kiosk 100.

In other embodiments of a system 1000, there may be groups of managers 400 in electronic communication with respective subsets of kiosks 100. Also, there may be one or more layers of managers 400 in electronic communication with each other.

Example Features

Example kiosks 100 will now be described with features in addition to those already described. In one embodiment, a dual-screen interactive advertising kiosk 100 is provided, with a lower touch screen and an upper advertising screen that responds based on the inputs to the lower touch screen. The example kiosk 100 plays music and other audio through one or more speakers and displays advertising on the screens when the kiosk 100 is interacted with by a user 201. Other information of interest may also be shown, such as local weather. Weather may also be searched, as the kiosk 100 is connected to the Internet. The kiosk 100 may also speak to the user 201 upon being touched or approached, by use of a pre-recorded voice message.

The example kiosk 100 provides the user 201 with various search options for products, services, and things to do and see in various categories, and provides the option to filter search results by such characteristics as price, distance, category, event, coupons, top coupons, and key words. Selecting an advertiser 301 in the search results brings up advertisements and information that the advertiser itself uploaded, including such things as company information, location with interactive map and turn-by-turn directions, pictures, coupons, fliers, menus, ticket sales with current ticket prices and availability, videos, online restaurant and hotel prices and reservations, hotel check-in/check-out, tee times, shipment tracking, fuel prices, directory assistance including reverse phone lookup, and flight schedule tracking, all live and in real time.

The example kiosk 100 also prints out and dispenses objects 150 such as hotel key cards, tickets, boarding passes, flight schedules, receipts, and the like. The example kiosk 100 thus provides a novel informational kiosk that provides comprehensive information for users 200 such as local consumers and travelers alike. The example kiosk 100 also allows advertisers to remotely upload and control their advertising in real time, and to dispense objects 150 such as gift cards, which are kept stocked within the kiosk 100 and may be programmed to correspond to the selected advertiser 301 upon being dispensed.

An example kiosk 100 may also provide face-to-face concierge help. In this example, the user 201 can activate a help request on the kiosk 100 to ask for assistance. A camera in the kiosk 100 allows a human assistant or manager 400 located remotely to see the user 201 and the user 201 may see the assistant or manager 400 on one of the kiosk screens. The assistant or manager 400 can then send to the user 201 real-time printable and/or electronic information through the network 500 to the kiosk 100, which may then automatically dispense or electronically transmit the information to the user 201.

An example kiosk 100 may also provide the ability for users 200 to take pictures of themselves using the kiosk 100, which can then send the pictures to a device 250 of the user 201.

Example kiosks 100 may allow users 200 to log-in to private accounts to personalize the experience of the users 200, for instance by placing their name on the screen and reminding them of their past actions and preferences.

Steps for Use

Example steps for utilizing various embodiments of the system 1000 will now be described. Regarding users' 200 interaction with the system 1000, a user 201 having a device 250 capable of receiving electronic communications may approach a kiosk 100 having input and output means, and interact with the input means, for instance by touching a touch screen. The device 250 may be any suitable device, including any of those described herein. The input and output means of the kiosk 100 may be any suitable means, including any of those described herein. The kiosk 100 may display information from advertisers regarding various goods and/or services, and may prompt the user 201 to select to receive additional information and/or an object 150 relating to certain of those goods or services. The object 150 may be any suitable object 150, including any of those described herein. The user 201 may select to receive additional information and/or an object 150 relating to certain of those goods or services. The kiosk 100 may prompt the user 201 to input information into the kiosk 100 identifying an address for electronic communications that the user's device 250 will receive. The user 201 may input that information into the kiosk 100. The output means of the kiosk 100 may dispense the selected object 150 relating to the goods or services, and/or may transmit the selected information relating to the goods or services to the device 250 through a network 500.

Regarding the interaction of other parties' 300 with the system 1000, one or more advertisers 301 et seq. may log-in to an electronic interface in a network 500, such as password-protected WebPages on the Internet available exclusively to each respective advertiser 301 et seq. The advertisers 301 et seq. can then upload and/or enter and/or select certain advertising-related content that the advertisers 301 et seq. desire to appear on one or more remotely located kiosks 100. The kiosks 100 then display that advertising-related content when selected by a user. Using the same or a similar interface, each advertiser 301 et seq. can also select certain objects 150 and/or information associated with that advertiser to be available from the kiosks 100 for dispensing and/or electronic communication to a user device 250, upon selection by a user 201. The kiosks then dispense those objects 150 when selected by a user 201, and/or electronically communicate that information to the user device 250 when selected by a user 201. The object 150 may be any suitable object 150, including any of those described herein. The information may be any suitable information, including any of the types of information described herein.

The above steps are set forth to illustrate general concepts. Numerous other steps, and combinations and permutations thereof, are contemplated, and are inherently and necessarily disclosed to persons of ordinary skill in the art by the description of the system herein.

Although exemplary embodiments and applications of the invention have been described herein, there is no intention that the invention be limited to these exemplary embodiments and applications or to the manner in which the exemplary embodiments and applications operate or are described herein. Indeed, many variations and modifications to the exemplary embodiments are possible. For example, although certain possible functionalities of the kiosks are shown and described, such as an ATM, the invention is not so limited. Rather, the invention may include or exclude any kiosk functionality as long as the resulting system or method falls within the scope of one of the following claims.

What is claimed is:

1) An interactive kiosk system, comprising:
at least one electronic kiosk located in a public place and adapted to provide a public user with information and objects relating to a plurality of parties, said kiosk:
having input means and output means;
in electronic communication with the parties through a network such that each party can remotely control the content and availability on the kiosk of each party's respective information and materials;
adapted to dispense an object relating to a party upon selection by the user; and
adapted to electronically communicate information relating to a party to a device of the user upon selection by the user.

2) The interactive kiosk system of claim 1, wherein the input means comprises a touch screen.

3) The interactive kiosk system of claim 1, wherein the object relating to a party is at least one of a: room key card; lottery ticket; receipt; map; gift card; event ticket; transportation ticket.

4) The interactive kiosk system of claim 1, wherein the information communicated to a device of the user is communicated in the form of at least one of an: email; SMS message; MMS message.

5) The interactive kiosk system of claim 1, wherein the information communicated to a device of the user comprises at least one of: a coupon; driving directions; reservations; contact information for the party; a menu.

6) The interactive kiosk system of claim 1, wherein the kiosk further comprises an ATM.

7) The interactive kiosk system of claim 1, further comprising a manager in electronic communication with the kiosk through a network such that the manager can control the parties' access to the kiosk.

8) The interactive kiosk system of claim 1, wherein the kiosk further comprises videoconferencing means, and the system further comprises a manager in electronic communication with the kiosk through a network such that the manager and the user can see and hear each other using the videoconferencing means.

9) The interactive kiosk system of claim 1, wherein the kiosk further comprises uniform interface means adapted to allow the user to interact with the reservation systems of a plurality of third-parties when the user's identification or payment information is entered only once.

10) A method of providing a public user with information relating to one of a plurality of parties, comprising:
providing a publicly located electronic kiosk: having input means and output means; in electronic communication with the plurality of parties through a network such that each party can remotely control the content and availability on the kiosk of each party's respective information and materials; adapted to dispense an object relating to a party upon selection by the user; and adapted to electronically communicate information relating to a party to a device of the user upon selection by the user; and
electronically communicating information relating to one of the parties to a device of the user upon the user's interaction with the kiosk.

11) The method of claim 10, further comprising:
dispensing an object relating to one of the parties upon the user's interaction with the kiosk.

12) The method of claim 10, wherein the information communicated to a device of the user is communicated in the form of at least one of an: email; SMS message; MMS message.

13) The method of claim 10, wherein the information communicated to a device of the user comprises at least one of: a coupon; driving directions; reservations; contact information for the party; a menu.

14) The method of claim 10, further comprising:
controlling the parties' access to the kiosk by electronically communicating with the kiosk through a network.

15) The method of claim 10, wherein the kiosk further comprises videoconferencing means, and the system further comprises a manager in electronic communication with the kiosk through a network such that the manager and the user can see and hear each other using the videoconferencing means, further comprising the step of: the manager and the user communicating with each other through the videoconferencing means.

16) A method of providing a public user with information relating to one of a plurality of parties, comprising:
providing a publicly located electronic kiosk: having input means and output means; in electronic communication with the plurality of parties through a network such that each party can remotely control the content and availability on the kiosk of each party's respective information and materials; adapted to dispense an object relating to a party upon selection by the user; and adapted to electronically communicate information relating to a party to a device of the user upon selection by the user; and
dispensing an object relating to one of the parties upon the user's interaction with the kiosk.

17) The method of claim 16, wherein the object relating to the party is at least one of a: room key card; lottery ticket; receipt; map; gift card; event ticket; transportation ticket.

18) The method of claim 16, wherein the kiosk further comprises an ATM.

19) The method of claim 16, wherein the kiosk further comprises videoconferencing means, and the system further comprises a manager in electronic communication with the kiosk through a network such that the manager and the user can see and hear each other using the videoconferencing means, further comprising the step of: the manager and the user communicating with each other through the videoconferencing means.

20) The method of claim 16, further comprising:
controlling the parties' access to the kiosk by electronically communicating with the kiosk through a network.
